(19) United States
(12) Patent Application Publication
(10) Pub. No.: US 2013/0127257 A1
(43) Pub. Date: May 23, 2013

(54) POWER GENERATING SYSTEM AND WIRELESS POWER TRANSMISSION SYSTEM

(71) Applicant: Panasonic Corporation, Osaka (JP)

(72) Inventors: Hiroshi YAMAMOTO, Osaka (JP); Hiroshi KANNO, Osaka (JP)

(73) Assignee: Panasonic Corporation, Osaka (JP)

(21) Appl. No.: 13/676,671

(22) Filed: Nov. 14, 2012

Related U.S. Application Data
(60) Provisional application No. 61/562,698, filed on Nov. 22, 2011.

(51) Int. Cl. H01F 38/14

(52) U.S. Cl. CPC H01F 38/14
USPC 307/104

(57) ABSTRACT

A power generating system includes: a plurality of power generating units for transmitting generated electric power by wireless via magnetic coupling between resonators; an AC combining section for combining AC energy output from AC converting and outputting sections of the power generating units and supplying the converted AC energy to an AC load; a DC combining section for combining DC energy output from DC converting and outputting sections of the power generating units and supplying the combined DC energy to a DC load; and an output control section for controlling an output of each power generating unit by transmitting a control signal to an output switching section of each power generating unit based on power consumption of at least one of the AC load and the DC load.

This application claims priority under 35 USC §119(e) to U.S. Provisional Application No. 61/562,698 filed on Nov. 22, 2011, the entire contents of which are incorporated herein by reference.

### BACKGROUND

1. Technical Field

The present disclosure relates to a power generating system and a wireless power transmission system for efficiently distributing electric power generated by a plurality of power generating units.

2. Description of the Related Art

There has been heretofore proposed a power distribution system for distributing AC power and DC power to loads (electronic products such as lighting) installed in a building. For example, Japanese Utility Model Application Laid-open Publication No. 4-128024 discloses a power distribution system capable of supplying DC power as well as AC power by providing a terminal for outputting DC power to an AC power outlet fixed to the wall of a room or the like. This power distribution system includes a distribution board having a transformer and a rectifier, and an AC power outlet provided with a DC output terminal. The transformer converts an AC voltage of 100 V or 200 V into an AC voltage of 6 V, 3 V, or 1.5 V to be used by an AC load, and outputs the converted AC voltage to the rectifier. The rectifier rectifies the AC voltage output from the transformer to convert the AC voltage into a DC voltage of 6 V, 3 V, or 1.5 V, and outputs the DC voltage to the DC output terminal provided to the outlet. This configuration enables electric power supplied from a commercial AC power supply to be distributed to an AC load and a DC load.

From the viewpoint of environmental conservation, on the other hand, it is becoming more popular to install a solar power generating system or a fuel cell power generating system in a house. In such a power generating system, DC power generated by a solar cell or a fuel cell is converted into AC power by a power conditioner. The converted AC power is output to, for example, an AC transmission system in the house. In the solar power generating system, when electric power consumed by loads in the house is smaller than electric power generated by the solar power generating system, surplus generated electric power is supplied to a commercial power transmission system (reverse power flow). In this way, electric power can be sold to an electric power company (electric power selling).

In the case of simply combining the power distribution system disclosed in Japanese Utility Model Application Laid-open Publication No. 4-128024 and the power generating system, a loss occurs when DC power output from a power generating device, such as a solar cell or a fuel cell, is supplied to a DC load. Specifically, the output DC power is once converted into AC power by the power conditioner, and is again converted into DC power in the power distribution system. Thus, the loss in power conversion becomes larger.

To deal with this problem, PCT International Application Publication No. 2010/016420A discloses a power distribution system for distributing DC power output from a power generating device directly and preferentially to a DC load. In this system, a DC load and an AC load are connected in parallel to an output power line of the power generating device, and electric power is distributed preferentially to the DC load. In this way, a loss caused by unnecessary power conversion is prevented from occurring in power distribution to the DC load.

On the other hand, United States Patent Application Publication No. 2008/0278264 (FIGS. 9 and 12) discloses a novel wireless power transmission device for transmitting energy (electric power) between two resonators through space. In this wireless power transmission device, the two resonators are coupled together via penetrating oscillation energy (evanescent tail) at the resonant frequency generated in space in the vicinity of the resonator, to thereby transmit the oscillation energy by wireless (contactless). This type of energy transmission utilizing magnetic field distribution as a resonator is called “resonant magnetic coupling type”.

There has been proposed a wireless power transmission type power generating system in which a resonant magnetic coupling type wireless power transmission system and a power generating system are combined (for example, PCT International Application Publication No. 2011/019088A). In this system, DC power generated by a power generating device is converted into high-frequency AC power (hereinafter referred to as “HF power” or “HF energy”) by a wireless power transmission unit, and is transmitted by wireless by a pair of antennas. The transmitted HF power is rectified and input to a power conditioner, and is supplied to a load, for example.

### SUMMARY

The conventional art techniques need further improvement in view of maintaining high performance of power distribution of the overall system, for example, in the case where part of the installation region is shaded (partial shading) or the characteristics of part of the installed cells or modules are deteriorated.

One non-limiting, and exemplary embodiment provides a wireless power transmission power generating system capable of efficiently distributing outputs from a plurality of power generating units.

In one general aspect, a wireless power transmission system includes a plurality of power transmission units, each of which includes: an oscillator configured to convert DC energy into high-frequency energy and output the converted high-frequency energy; a transmitting antenna configured to transmit the high-frequency energy output from the oscillator; a receiving antenna configured to receive at least part of the high-frequency energy transmitted by the transmitting antenna; an AC converting and outputting section configured to convert the high-frequency energy into AC energy having a relatively low frequency and outputting the converted AC energy; a DC converting and outputting section configured to convert the high-frequency energy into DC energy and outputting the converted DC energy; and an output switching section configured to connect a plurality of outputting sections including the AC converting and outputting section and the DC converting and outputting section to the receiving antenna, the output switching section being configured to transmit the high-frequency energy received by the receiving antenna to any one of the plurality of outputting sections based on a control signal. The system further includes: an AC combining section configured to combine AC energy output from the AC converting and outputting sections of the plurality of power transmission units and supplying the combined AC energy to an AC load; a DC combining section configured to combine DC energy output from the DC converting and outputting sections of the plurality of power transmission units and supplying the combined DC energy to a DC load; and an output control section configured to control an output of each of the plurality of power transmission units by transmitting the control signal to the output switching section of each of the plurality of power transmission units based on power consumption of at least one of the AC load and the DC load.

In another general aspect, a wireless power transmission system includes a plurality of power transmission units, each of which includes: an oscillator configured to convert DC energy into high-frequency energy and output the converted high-frequency energy; a transmitting antenna configured to transmit the high-frequency energy output from the oscillator; a receiving antenna configured to receive at least part of the high-frequency energy transmitted by the transmitting antenna; an AC converting and outputting section configured to convert the high-frequency energy into AC energy having a relatively low frequency and outputting the converted AC energy; an HF outputting section configured to output the received high-frequency energy without any conversion; and an output switching section configured to connect a plurality of outputting sections including the AC converting and outputting section and the HF outputting section to the receiving antenna, the output switching section being configured to transmit the high-frequency energy received by the receiving antenna to any one of the plurality of outputting sections based on a control signal. The system further includes: an AC combining section configured to combine AC energy output from the AC converting and outputting sections of the plurality of power transmission units and supplying the combined AC energy to an AC load; an HF combining section configured to combine the high-frequency energy output from the HF outputting sections of the plurality of power transmission units and supplying the combined high-frequency energy to an HF load; and an output control section configured to control an output of each of the plurality of power transmission units by transmitting the control signal to the output switching section of each of the plurality of power transmission units based on power consumption of at least one of the AC load and the HF load.

According to an exemplary embodiment of the present disclosure, the number of power conversions in the overall system can be reduced as compared to the case where outputs of all power generating units are converted at one time into AC power or DC power of a predetermined voltage. Electric power generated by the power generating units can therefore be distributed efficiently.

These general and specific aspects may be implemented using a system, a method, and a computer program, and any combination of systems, methods, and computer programs.

Additional benefits and advantages of the disclosed embodiments will be apparent from the specification and Figures. The benefits and/or advantages may be individually provided by the various embodiments and features of the specification and drawings disclosure, and need not all be provided in order to obtain one or more of the same.

### BRIEF DESCRIPTION OF THE DRAWINGS

FIG. 1 is a block diagram illustrating a configuration of a power generating system according to an embodiment of the present disclosure.

FIG. 2 is a block diagram illustrating a configuration of one power generating unit in the embodiment of the present disclosure.

FIG. 3 is a diagram illustrating an exemplary circuit configuration of an oscillator 102 in the embodiment of the present disclosure.

FIG. 4 is an equivalent circuit diagram of a transmitting antenna and a receiving antenna in the embodiment of the present disclosure.

FIG. 5A is a circuit diagram of a half-wave voltage doubler rectifier circuit usable in the embodiment of the present disclosure.

FIG. 5B is a circuit diagram of a full-wave voltage doubler rectifier circuit usable in the embodiment of the present disclosure.

FIG. 6A is a circuit diagram of a single-phase output inverter usable in the embodiment of the present disclosure.

FIG. 6B is a circuit diagram of a three-phase output inverter usable in the embodiment of the present disclosure.

FIG. 6C is a circuit diagram of a V-connection inverter usable in the embodiment of the present disclosure.

FIG. 7 is a circuit diagram of a boost chopper usable in the embodiment of the present disclosure.

FIG. 8A is a circuit diagram of an indirect matrix converter usable in the embodiment of the present disclosure.

FIG. 8B is a circuit diagram of a direct matrix converter usable in the embodiment of the present disclosure.

FIG. 9 is a diagram illustrating an exemplary configuration of a DC combining section in the embodiment of the present disclosure.

FIG. 10 is a diagram illustrating an exemplary configuration of an AC combining section and an HF combining section in the embodiment of the present disclosure.

FIG. 11 is a table showing an example of the power generation amount of each power generating unit and power consumption of each load.

FIG. 12A is a graph showing an example of a result of adjusting an output of each power generating unit by an output control section.

FIG. 12B is a graph showing another example of the result of adjusting the output of each power generating unit by the output control section.

FIG. 13 is a flowchart illustrating an exemplary algorithm of operation performed by the output control section.

FIG. 14 is an equivalent circuit diagram illustrating a boosting effect in the embodiment of the present disclosure.

FIG. 15 is a block diagram illustrating a configuration example in another embodiment of the present disclosure.

### DETAILED DESCRIPTION

Referring to the accompanying drawings, embodiments of the present disclosure are described below.

In one general aspect, a power generating system includes a plurality of power generating units, each of which includes: a power generating device configured to output DC energy; an oscillator configured to convert the DC energy output from the power generating device into high-frequency energy and output the converted high-frequency energy; a transmitting antenna configured to transmit the high-frequency energy output from the oscillator; a receiving antenna configured to receive at least part of the high-frequency energy transmitted by the transmitting antenna; an AC converting and outputting section configured to convert the high-frequency energy into AC energy having a relatively low frequency and outputting the converted AC energy; a DC converting and outputting section configured to convert the high-frequency energy into DC energy and outputting the converted DC energy; and an output switching section configured to connect a plurality of outputting sections including the AC converting and outputting section and the DC converting and outputting section to the receiving antenna, the output switching section being configured to transmit the high-frequency energy received by the receiving antenna to any one of the plurality of outputting sections based on a control signal. The system further includes: an AC combining section configured to combine AC energy output from the AC converting and outputting sections of the plurality of power generating units and supplying the combined AC energy to an AC load; a DC combining section configured to combine DC energy output from the DC converting and outputting sections of the plurality of power generating units and supplying the combined DC energy to a DC load; and an output control section configured to control an output of each of the plurality of power generating units by transmitting the control signal to the output switching section of each of the plurality of power generating units based on power consumption of at least one of the AC load and the DC load.

In one embodiment, the output control section generates the control signal based on power consumption of both of the AC load and the DC load.

In another embodiment, the power generating system further includes: an AC power detecting section configured to detect the power consumption of the AC load and notifying the output control section of the detected power consumption; and a DC power detecting section configured to detect the power consumption of the DC load and notifying the output control section of the detected power consumption.

In another embodiment, each of the plurality of power generating units further includes a generated energy detecting section for detecting a magnitude of the high-frequency energy output from the receiving antenna; and the output control section generates the control signal based on the magnitude of the high-frequency energy detected by the generated energy detecting section.

In another embodiment, each of the plurality of power generating units further includes an HF outputting section configured to output the received high-frequency energy without any conversion. The power generating system further includes: an HF combining section configured to combine the high-frequency energy output from the HF outputting sections of the plurality of power generating units and supplying the combined HF energy to an HF load; and the output control section controls the output of each of the plurality of power generating units based on power consumption of the HF load.

In another embodiment, the output control section controls the output of each of the plurality of power generating units so that electric power supply to the HF load has priority over electric power supply to the AC load and the DC load.

In another embodiment, each of the plurality of power generating units further includes an HF power detecting section configured to detect the power consumption of the HF load and notifying the output control section of the detected power consumption.

In another embodiment, the output control section controls the output of each of the plurality of power generating units based on the power consumption of each of the AC load, the DC load, and the HF load detected by a current amount flowing through each of the AC load, the DC load, and the HF load.

In another embodiment, the output control section transmits the control signal to the output switching section in each of the plurality of power generating units so that the current amount flowing through the AC load, the DC load, and the HF load approaches 0.

In another embodiment, the AC combining section is connected to a power grid.

In another embodiment, one of the transmitting antenna and the receiving antenna in each of the plurality of power generating units includes a series resonance circuit and the other includes a parallel resonance circuit.

In another embodiment, the following equation is satisfied: (L2/L1)≧(k/Voc)2, where Voc represents a voltage step-up ratio of the oscillator, L1 represents an inductance of an inductor included in the transmitting antenna, L2 represents an inductance of an inductor included in the receiving antenna, and k represents a coupling coefficient between the transmitting antenna and the receiving antenna in each of the plurality of power generating units.

In another general aspect, a power generating system includes a plurality of power generating units, each of which includes: a power generating device configured to output DC energy; an oscillator configured to convert the DC energy output from the power generating device into high-frequency energy and output the converted high-frequency energy; a receiving antenna configured to receive at least part of the high-frequency energy transmitted by the transmitting antenna; an AC converting and outputting section configured to convert the high-frequency energy into AC energy having a relatively low frequency and outputting the converted AC energy; an HF outputting section configured to output the received high-frequency energy without any conversion; and an output switching section configured to connect a plurality of outputting sections including the AC converting and outputting section and the HF outputting section to the receiving antenna, the output switching section being configured to transmit the high-frequency energy received by the receiving antenna to any one of the plurality of outputting sections based on a control signal. The system further includes: an AC combining section configured to combine AC energy output from the AC converting and outputting sections of the plurality of power generating units and supplying the combined AC energy to an AC load; an HF combining section configured to combine the high-frequency energy output from the HF outputting sections of the plurality of power generating units and supplying the combined high-frequency energy to an HF load; and an output control section configured to control an output of each of the plurality of power generating units by transmitting the control signal to the output switching section of each of the plurality of power generating units based on power consumption of at least one of the AC load and the HF load.

In another general aspect, a wireless power transmission system includes a plurality of power transmission units, each of which includes: an oscillator configured to convert DC energy into high-frequency energy and output the converted high-frequency energy; a transmitting antenna configured to transmit the high-frequency energy output from the oscillator; a receiving antenna configured to receive at least part of the high-frequency energy transmitted by the transmitting antenna; an AC converting and outputting section configured to convert the high-frequency energy into AC energy having a relatively low frequency and outputting the converted AC energy; a DC converting and outputting section configured to convert the high-frequency energy into DC energy and outputting the converted DC energy; and an output switching section configured to connect a plurality of outputting sections including the AC converting and outputting section and the DC converting and outputting section to the receiving antenna, the output switching section being configured to transmit the high-frequency energy received by the receiving antenna to any one of the plurality of outputting sections based on a control signal. The system further includes: an AC combining section configured to combine AC energy output from the AC converting and outputting sections of the plurality of power transmission units and supplying the combined AC energy to an AC load; a DC combining section configured to combine DC energy output from the DC converting and outputting sections of the plurality of power transmission units and supplying the combined DC energy to a DC load; and an output control section configured to control an output of each of the plurality of power transmission units by transmitting the control signal to the output switching section of each of the plurality of power transmission units based on power consumption of at least one of the AC load and the DC load.

In another general aspect, a wireless power transmission system includes a plurality of power transmission units, each of which includes: an oscillator configured to convert DC energy into high-frequency energy and output the converted high-frequency energy; a transmitting antenna configured to transmit the high-frequency energy output from the oscillator; a receiving antenna configured to receive at least part of the high-frequency energy transmitted by the transmitting antenna; an AC converting and outputting section configured to convert the high-frequency energy into AC energy having a relatively low frequency and outputting the converted AC energy; an HF outputting section configured to output the received high-frequency energy without any conversion; and an output switching section configured to connect a plurality of outputting sections including the AC converting and outputting section and the HF outputting section to the receiving antenna, the output switching section being configured to transmit the high-frequency energy received by the receiving antenna to any one of the plurality of outputting sections based on a control signal. The system further includes: an AC combining section configured to combine AC energy output from the AC converting and outputting sections of the plurality of power transmission units and supplying the combined AC energy to an AC load; an HF combining section configured to combine the high-frequency energy output from the HF outputting sections of the plurality of power transmission units and supplying the combined high-frequency energy to an HF load; and an output control section configured to control an output of each of the plurality of power transmission units by transmitting the control signal to the output switching section of each of the plurality of power transmission units based on power consumption of at least one of the AC load and the HF load.

Hereinafter, embodiments of the present disclosure will be described more specifically.

A power generating system in this embodiment is a solar power generating system for use in a single-family residence. However, the power generating system in this embodiment is not limited to a single-family residence but is also applicable to an individual residence in a collective housing, an office, a building, and the like.

(Overall Configuration)

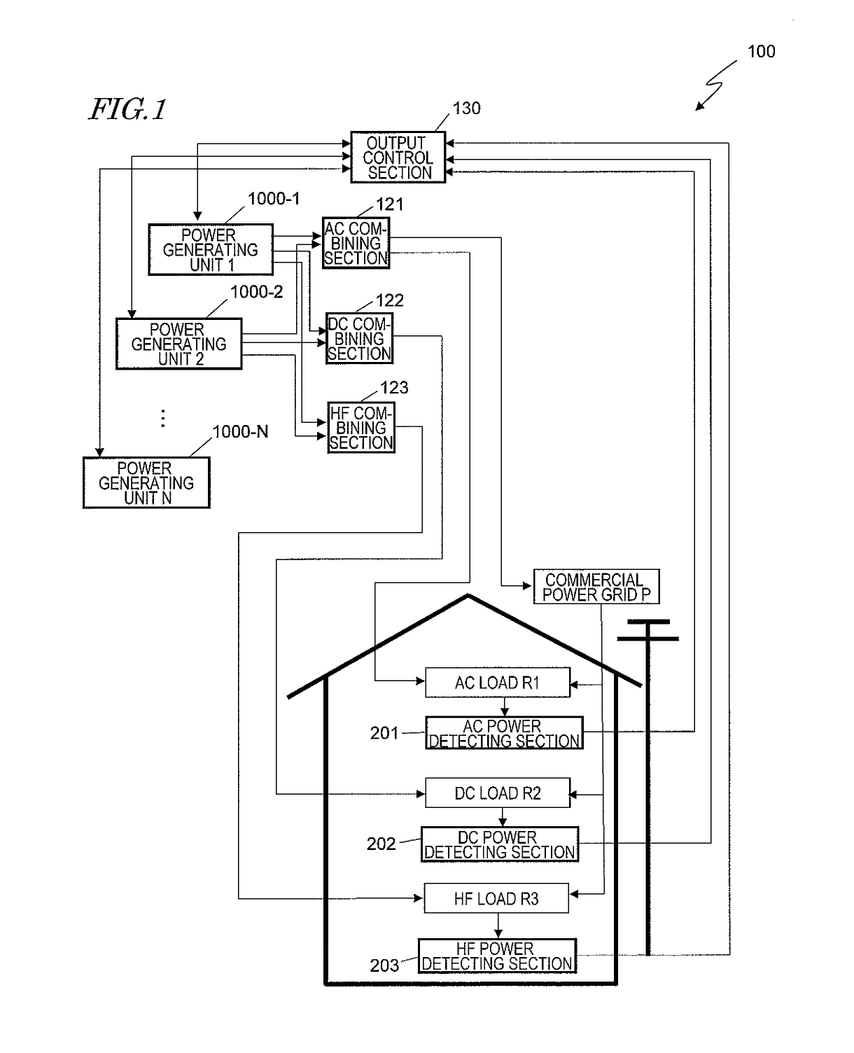

FIG. 1 is a block diagram illustrating an overall configuration of a power generating system 100 in this embodiment. FIG. 1 also illustrates an AC load R1, a DC load R2, an HF load R3, and a commercial power grid P, which are not the components of the power generating system 100. The AC load R1 represents all kinds of loads that operate with alternating-current (AC) power, such as AC home appliances. The DC load R2 represents all kinds of loads that operate with direct-current (DC) power, such as DC home appliances and a battery. The HF load R3 represents all kinds of loads that operate with high-frequency (HF) power, such as wireless power transmission applied home appliances and a non-contact rechargeable electric vehicle. The loads of the AC load R1, the DC load R2, and the HF load R3 are each placed inside the house or in the vicinity of the house and are supplied with AC power (50 V or 60 V) from the commercial power grid P. Although not illustrated in FIG. 1, the house has a distribution board placed therein, for distributing the AC power supplied from the commercial power grid P to the respective loads after performing necessary processing such as voltage transformation, rectification, and frequency conversion.

In this specification, “high-frequency” means a higher frequency than the commercial AC frequency (50 Hz or 60 Hz). For example, a frequency in the range of several hundred Hz to 300 GHz, more preferably 100 kHz to 10 GHz, still more preferably 500 kHz to 20 MHz may be used. Depending on the application, a frequency in the range of 10 kHz to 1 GHz or in the range of 20 kHz to 20 MHz may be used. In this embodiment, recharging a secondary battery mounted in an electric vehicle or home appliances may be performed by wireless power transmission using a frequency in the range of 10 kHz to 10 MHz, for example.

The power generating system 100 illustrated in FIG. 1 includes N (N is an integer of 2 or more) power generating units 1000-1 to 1000-N. Each power generating unit is capable of transmitting an output corresponding to a single solar cell panel by wireless in a selected one of the three output forms of AC power, DC power, and HF power. The number N of the power generating units is set as appropriate depending on the required electrical energy. For example, when the required electrical energy is 3 kW and the power generation of each solar battery panel is 200 W, the number of the power generating units is about 15.

The power generating system 100 further includes an AC combining section 121, a DC combining section 122, and an HF combining section 123 which are connected to the power generating units. The AC combining section 121 combines AC power output from the power generating units and supplies the combined AC power to the AC load R1. The DC combining section 122 combines DC power output from the power generating units and supplies the combined DC power to the DC load R2. The HF combining section 123 combines HF power output from the power generating units and supplies the combined HF power to the HF load R3.

The power generating system 100 further includes an AC power detecting section 201 for detecting power consumption of the AC load R1, a DC power detecting section 202 for detecting power consumption of the DC load R2, an HF power detecting section 203 for detecting power consumption of the HF load R3, and an output control section 130 for controlling an output of each power generating unit based on the power consumption of the loads. The configurations of the respective sections are described in detail below.

(Power Generating Unit)

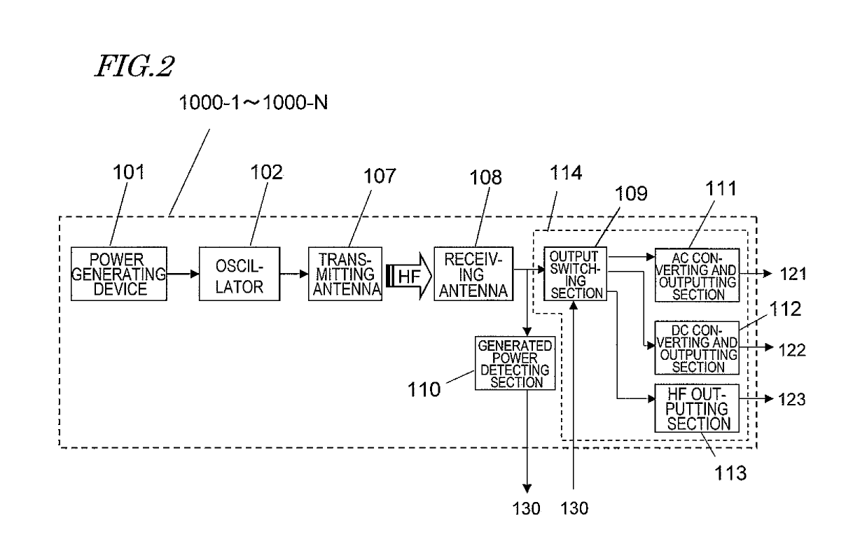

FIG. 2 is a block diagram illustrating an individual configuration of the power generating units 1000-1 to 1000-N. Each power generating unit includes a power generating device 101 for generating DC power by a solar cell panel, an oscillator 102 for converting the DC power generated by the power generating device 101 into HF power, a transmitting antenna 107 for transmitting the HF power, and a receiving antenna 108 for receiving at least part of the transmitted HF power and outputting the HF power. In this manner, electric power generated by the power generating device 101 is transmitted by wireless via the transmitting/receiving antennas. Each power generating unit further includes an outputting section 114 for receiving the HF power output from the receiving antenna 108 and outputting a selected one of the AC power, DC power, and HF power, and a generated energy detecting section 110 for detecting the magnitude of the HF power output from the receiving antenna 108. The outputting section 114 includes an AC converting and outputting section 111 for converting the HF power into AC power having a relatively low frequency and outputs the converted AC power, a DC converting and outputting section 112 for converting the HF power into DC power and outputs the converted DC power, an HF outputting section 113 for directly outputting the HF power without any conversion, and an output switching section 109 for electrically connecting one of the AC converting and outputting section 111, the DC converting and outputting section 112, and the HF outputting section 113 to the receiving antenna 108. The output switching section 109 switches an output destination in response to a control signal from the output control section 130 illustrated in FIG. 1. Control by the output control section 130 is described in detail later.

(Power Generating Device)

The power generating device 101 in this embodiment is a solar power generating device including a plurality of solar power generation modules connected in series. In view of improving power generation efficiency, the solar power generation module is preferred to use a crystalline silicon-based solar power generation element. The solar power generation module, however, may be various kinds of solar power generation modules using compound semiconductor materials such as gallium arsenide and CIS-based materials, and may be various kinds of solar power generation modules using organic materials. The crystal structure of semiconductors to be used may be any of single crystal, polycrystal, and amorphous. It is also possible to use a tandem type solar power generation module, in which various kinds of semiconductor materials are laminated. DC power generated by the power generating device 101 is transmitted to the oscillator 102.

(Oscillator)

The oscillator 102 is a so-called class-E or class-D oscillation circuit whose oscillation frequency is set to f0, for example. Alternatively, a class-F amplifier or a Doherty amplifier may be used instead. A high-efficiency sine wave may be generated by disposing a low-pass filter or a band-pass filter at a subsequent stage of a switching element that generates an output signal containing a strain component.

The oscillation frequency f0 is set to a frequency higher than the commercial AC frequency (50 Hz or 60 Hz). The oscillation frequency f0 may be set, for example, several hundred Hz to 300 GHz, more preferably 100 kHz to 10 GHz, still more preferably 500 kHz to 20 MHz. Depending on the application, the oscillation frequency f0 may be set in the range of 10 kHz to 1 GHz or in the range of 20 kHz to 20 MHz.

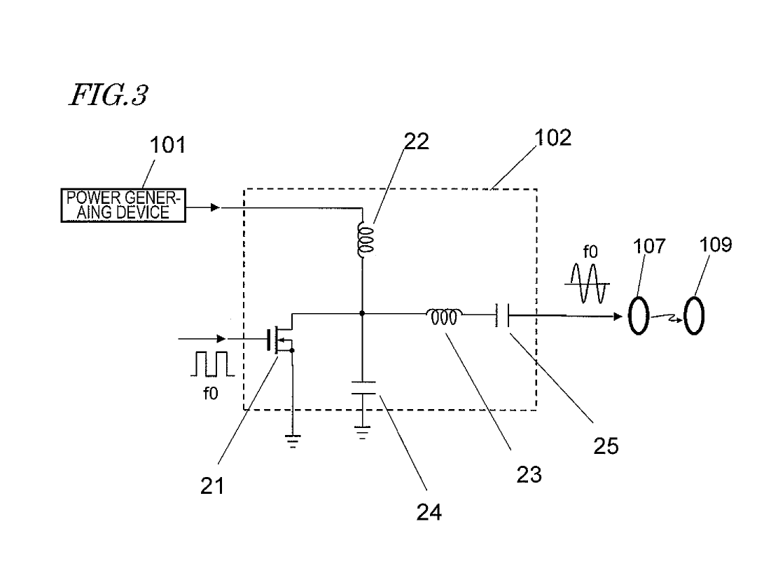

FIG. 3 is a diagram illustrating an exemplary circuit configuration of the oscillator 102 in this embodiment. This configuration is typically called “class-E oscillation circuit”. The oscillator 102 includes a switching element 21 such as a metal-oxide semiconductor field-effect transistor (MOSFET), an inductor 22, a capacitor 24, and an inductor 23 and a capacitor 25 forming a series resonance circuit. A pulse train of the frequency f0 is input as a gate drive pulse to the switching element 21. The inductance of the inductors 22 and 23 and the capacitance of the capacitors 24 and 25 are adjusted so that HF power output from the oscillator 102 has the frequency f0. With this configuration, DC power input from the power generating device 101 is converted into HF power of the frequency f0 and is transmitted to the transmitting antenna 107.

(Transmitting Antenna and Receiving Antenna)

As illustrated in FIG. 4, the transmitting antenna 107 is a series resonance circuit in which a first inductor 107a and a first capacitive element 107b are connected in series. The receiving antenna 108, on the other hand, is a parallel resonance circuit in which a second inductor 108a and a second capacitive element 108b are connected in parallel. Resonant frequencies of the antennas are set so as to be substantially equal to the oscillation frequency f0 of the oscillator 102. The series resonance circuit of the transmitting antenna 107 has a parasitic resistance component R1. The parallel resonance circuit of the receiving antenna 108 has a parasitic resistance component R2. The HF power input to the transmitting antenna 107 is transmitted by wireless to the receiving antenna 108 by means of resonant magnetic coupling between the transmitting antenna 107 and the receiving antenna 108.

The transmitting antenna 107 and the receiving antenna 108 are not in contact with each other but are spaced apart by about several millimeters to several meters, for example. Each of the transmitting antenna 107 and the receiving antenna 108 is not a normal antenna for transmitting/receiving a signal, but is an element for transferring energy (power) from one of two objects to the other by using a coupling phenomenon that has been produced by the near component (evanescent tail) of the electromagnetic field. According to such a wireless power transmitting technology that uses the resonant electromagnetic field, energy loss, which would otherwise be caused when an electromagnetic wave is transferred to a distant location, is not caused, and therefore, the power can be transmitted with very high efficiency. Such an energy transmitting technology that uses the coupling phenomenon of a resonant electromagnetic field (i.e., a near field) can achieve a longer transmission distance than that of a known non-contact power transmission that uses the Faraday's law of electromagnetic induction. For example, energy can be transferred between two antennas, which have an interval of as long as several meters between the antennas.

To carry out a wireless power transmission based on such a principle, two antennas need to be coupled together by resonant magnetic coupling. In particular, in order to realize high-efficiency energy transmission, a resonant frequency fT of the transmitting antenna 107 and a resonant frequency fR of the receiving antenna 108 are set to values close to each other. In this embodiment, fT≈fR=f0 is established, but the transmitting antenna 107 and the receiving antenna 108 do not necessarily strictly satisfy fT≈fR=f0, as long as electric power can be transmitted in a non-contact manner by means of resonant magnetic coupling at the frequency f0.

In this embodiment, when a voltage step-up ratio of the oscillator 102 is represented by Voc, inductances of the first and second inductors 107a and 108a are represented by L1 and L2, respectively, and a coupling coefficient between the first and second antennas 107 and 108 is represented by k, those L1, L2, k and Voc values are determined so as to satisfy the following relationship.

(L2/L1)≧(k/Voc)² (Eq. 1)

As described later in detail, when the relation of Equation 1 is satisfied, the output voltage of HF power can be increased to at least twice as high as the voltage of DC power input to the oscillator 102 (voltage step-up ratio: 2 or more) through wireless transmission. This action enables efficient boosting of low voltage power at the transmission, and hence, even when the output voltage of the power generating device 101 is low, arbitrary high voltage power can be output due to the boost effect. In the case where the above-mentioned relation is satisfied, it is unnecessary to connect a plurality of the power generating devices 101 in series for increasing the voltage, but the power generating units can be operated in parallel.

From the viewpoint of transmission efficiency, it is preferred that the transmitting antenna 107 and the receiving antenna 108 be opposed to each other. Otherwise, the transmitting antenna 107 and the receiving antenna 108 only need to avoid being disposed orthogonal to each other.

In order to suppress multiple reflections of energy between circuit blocks to improve overall power generation efficiency, it is preferred that the output impedance of energy at the frequency f0 output from the oscillator 102 and the input impedance of the transmitting antenna 107 be equal to each other under the state where an output terminal of the receiving antenna 108 is connected to the subsequent outputting section 114 or the like.

Power transmission efficiency in this embodiment depends on the interval (antenna interval) between the transmitting antenna 107 and the receiving antenna 108 and the magnitude of loss of the circuit elements forming the transmitting antenna 107 and the receiving antenna 108. Note that, the “antenna interval” is substantially the interval between the inductor 107a of the transmitting antenna 107 and the inductor 108a of the receiving antenna 108. The antenna interval can be evaluated with reference to the size of an antenna arrangement region (the region occupied by the antennas).

In this embodiment, the inductor 107a of the transmitting antenna 107 and the inductor 108a of the receiving antenna 108 both extend in a plane and are disposed in parallel and opposite to each other. The size of the antenna arrangement region as used herein means the size of an arrangement region of an antenna having a relatively smaller size, and is defined to be the diameter of the inductor when the profile of the inductor forming the antenna is circular, defined to be the length of each side of the inductor when the profile is square, and defined to be the length of the short side of the inductor when the profile is rectangular. According to this embodiment, even when the antenna interval is about 1.5 times as large as the size of the antenna arrangement region, energy can be transmitted at a wireless transmission efficiency of 90% or more.

Each of the inductor 107a of the transmitting antenna 107 and the inductor 108a of the receiving antenna 108 in this embodiment has a spiral structure with turns N1 and N2 (N1>1, N2>1). Alternatively, however, the inductors 107a and 108a may have a loop structure with a single turn. Those inductors 107a and 108a are not necessarily formed of a single-layer conductor pattern, but may be formed of a plurality of laminated conductor patterns connected in series.

Those inductors 107a and 108a may be formed preferably from a conductor having good conductivity such as copper or silver. A high-frequency current component of energy output from the oscillator 102 flows on the surface of the conductor in a concentrated manner, and hence the surface of the conductor may be coated with a high-conductivity material for the purpose of improving power generation efficiency. If those inductors are formed from a structure having a hollow at the center of the cross-section of a conductor, the reduction in weight can be realized. In addition, if the inductors are formed by adopting a parallel wire structure such as litz wire, a conductor loss for each unit length can be reduced. Thus, the Q factors of the series resonance circuit and the parallel resonance circuit can be improved. As a result, higher-efficiency power transmission can be performed.

For suppressing manufacturing cost, wirings may be formed at once with the use of ink printing technology. A magnetic substance may be disposed in the vicinity of the inductors of the transmitting antenna 107 and the receiving antenna 108, but it is not preferred to set the coupling coefficient k between those inductors to be an extremely high value. It is therefore more preferred to use an inductor having a air-core spiral structure capable of setting an appropriate coupling coefficient k.

Each inductor typically has a coil shape. However, the shape is not limited thereto. At a high-frequency, a conductor having a certain line length has inductance and therefore functions as an inductor. As another example, a conductor obtained simply by inserting conductive wire through a ferrite bead also functions as an inductor.

As the capacitive elements of the transmitting antenna 107 and the receiving antenna 108, any type of capacitor, including a chip capacitor and a lead capacitor, can be used. It is also possible to use the capacitance between two wirings via air to function as a capacitive element. In the case of forming those capacitive elements from MIM capacitors, a low-loss capacitor circuit can be formed by using a known semiconductor process or multilayer substrate process.

The Q factor of each resonator forming the transmitting antenna 107 and the receiving antenna 108 depends on antenna-to-antenna power transmission efficiency required by a system and the value of the coupling coefficient k, but is set to preferably 100 or more, more preferably 200 or more, still more preferably 500 or more, further preferably 1,000 or more. To realize a higher Q factor, it is effective to adopt the above-mentioned litz wire.

(Output Switching Section)

HF power boosted by wireless power transmission is transmitted to the output switching section 109. The output switching section 109 is, for example, a known semiconductor switch. In accordance with a control signal transmitted from the output control section 130, the output switching section 109 electrically connects any one of the AC converting and outputting section 111, the DC converting and outputting section 112, and the HF outputting section 113 to the receiving antenna 108. The HF power received by the receiving antenna 108 is thus transmitted to any one of the AC converting and outputting section 111, the DC converting and outputting section 112, and the HF outputting section 113.

(DC Converting and Outputting Section)

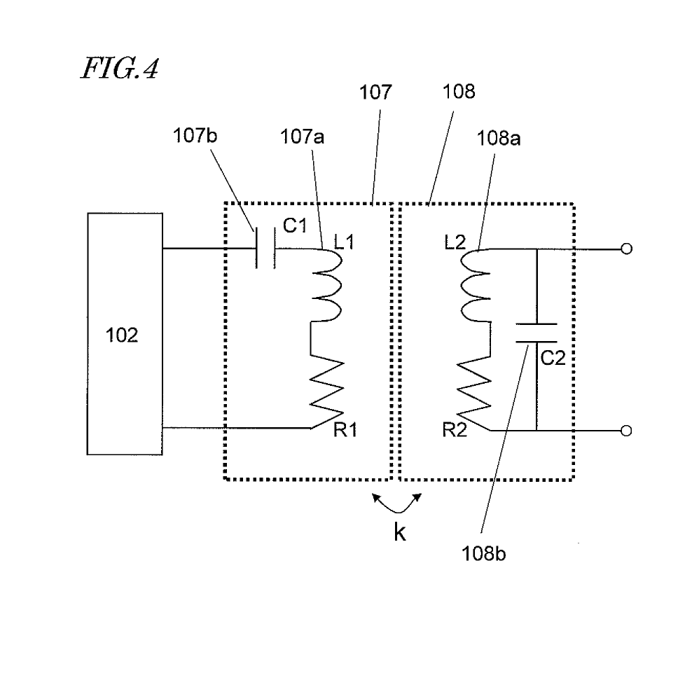

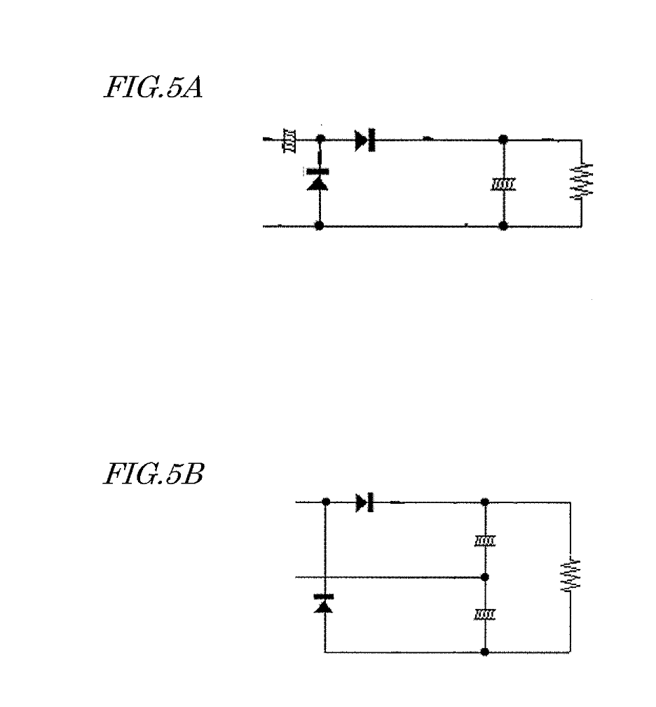

The DC converting and outputting section 112 converts the input HF power into DC power and outputs the converted DC power to the DC combining section 122. The DC converting and outputting section 112 is a rectifier circuit, such as a half-wave rectifier circuit, a full-wave rectifier circuit, and a bridge rectifier circuit. FIG. 5A is an exemplary circuit diagram of a half-wave voltage doubler rectifier circuit. FIG. 5B is an exemplary circuit diagram of a full-wave voltage doubler rectifier circuit. Both of the rectifier circuits include passive elements such as diodes. In addition, a high boost rectifier circuit capable of realizing a voltage step-up ratio of 3 or more is available. Those rectifier circuits are all applicable to this embodiment.

With the use of the voltage doubler rectifier circuit exemplified in FIG. 5A or 5B, a DC voltage boosted to twice as high as the voltage input to the DC converting and outputting section 112 can be output. The use of such a rectifier circuit can realize a further boosting effect in addition to the boosting effect obtained by wireless power transmission.

Note that, the rectifier circuit is not limited to the above-mentioned circuit including passive elements such as diodes. For example, a circuit for rectifying the voltage by controlling ON/OFF of a gate of an FET in response to an external clock, as exemplified by a synchronous rectifier circuit, may be adopted.

(AC Converting and Outputting Section)

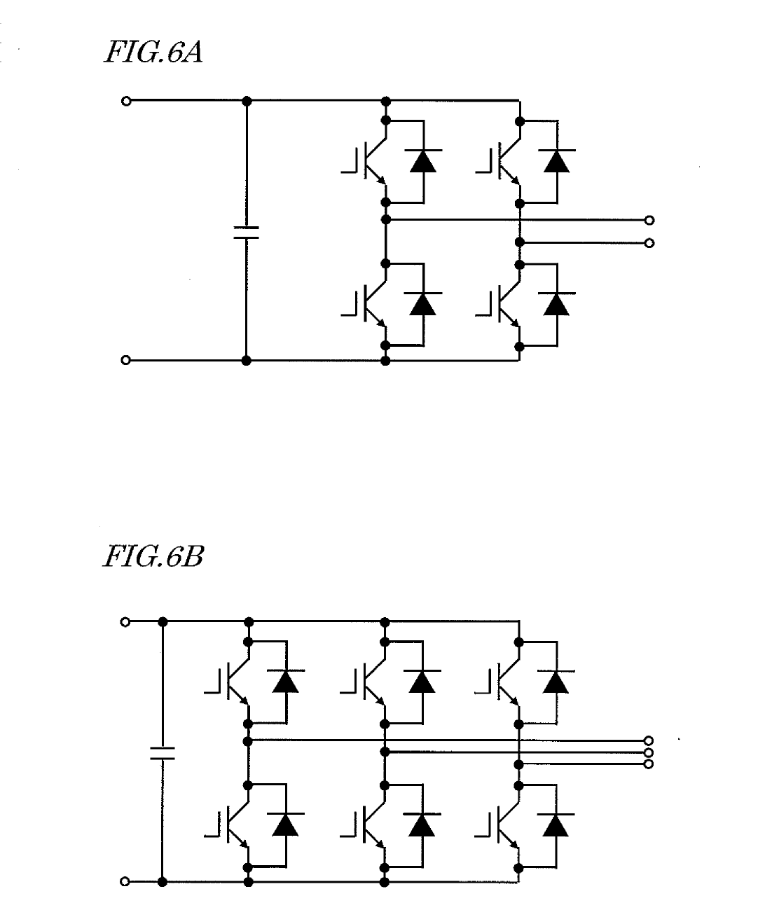

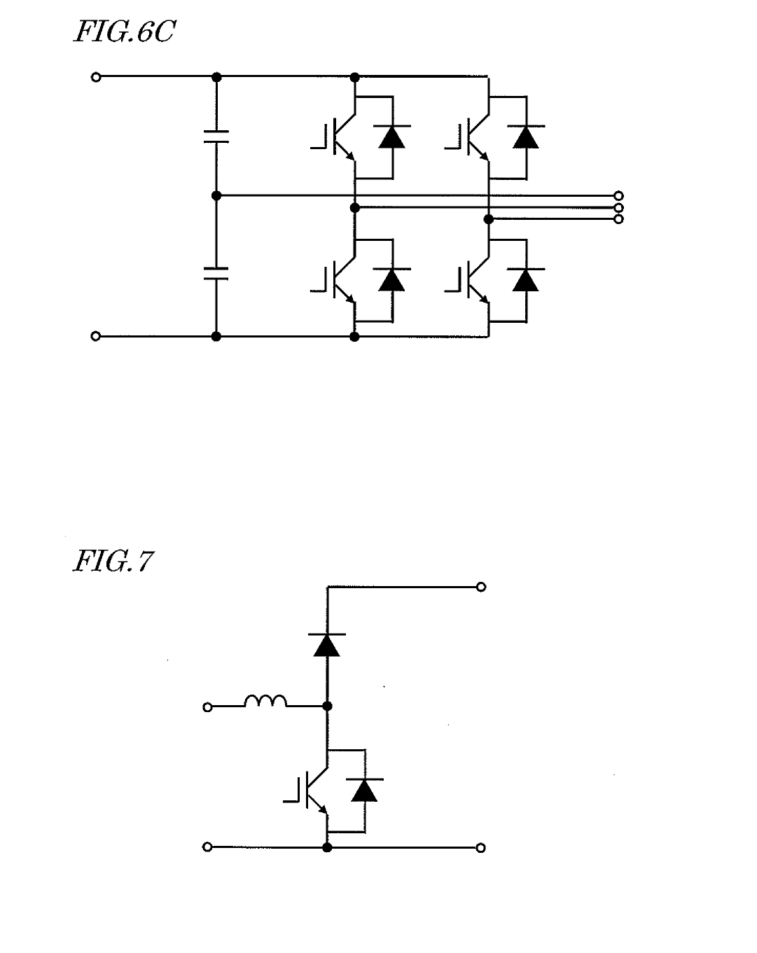

The AC converting and outputting section 111 converts the input HF power into AC power having a frequency of 50 Hz or 60 Hz, which is the same as the frequency of the commercial power grid, and outputs the converted AC power to the AC combining section 121. An applicable frequency conversion method of the AC converting and outputting section 111 is, for example, a method of converting HF power into DC power once and thereafter converting the DC power into AC of 50 Hz or 60 Hz. As the circuit for converting DC power into AC power at the subsequent stage of the rectifier circuit, for example, an inverter can be used. FIG. 6A is a circuit diagram of a single-phase output inverter. FIG. 6B is a circuit diagram of a three-phase output inverter. FIG. 6C is a circuit diagram of a V-connection inverter.

With the use of the inverter exemplified in FIG. 6A, 6B, or 6C, the rectified DC power can be converted in accordance with the frequency of the load or the system and be output. After DC-AC conversion is performed at the subsequent stage, the converted AC power may be subjected to an AC filter. With the use of such a filter, an undesirable harmonic, noise component, or the like can be removed in the case of reverse power flow to the system or the case of selling electric power, for example.

Further, a boost chopper circuit exemplified in FIG. 7 may be provided at a preceding stage of the inverter circuit. By providing the boost chopper circuit, the voltage of DC energy can be increased in advance before being converted into AC energy by the inverter circuit.

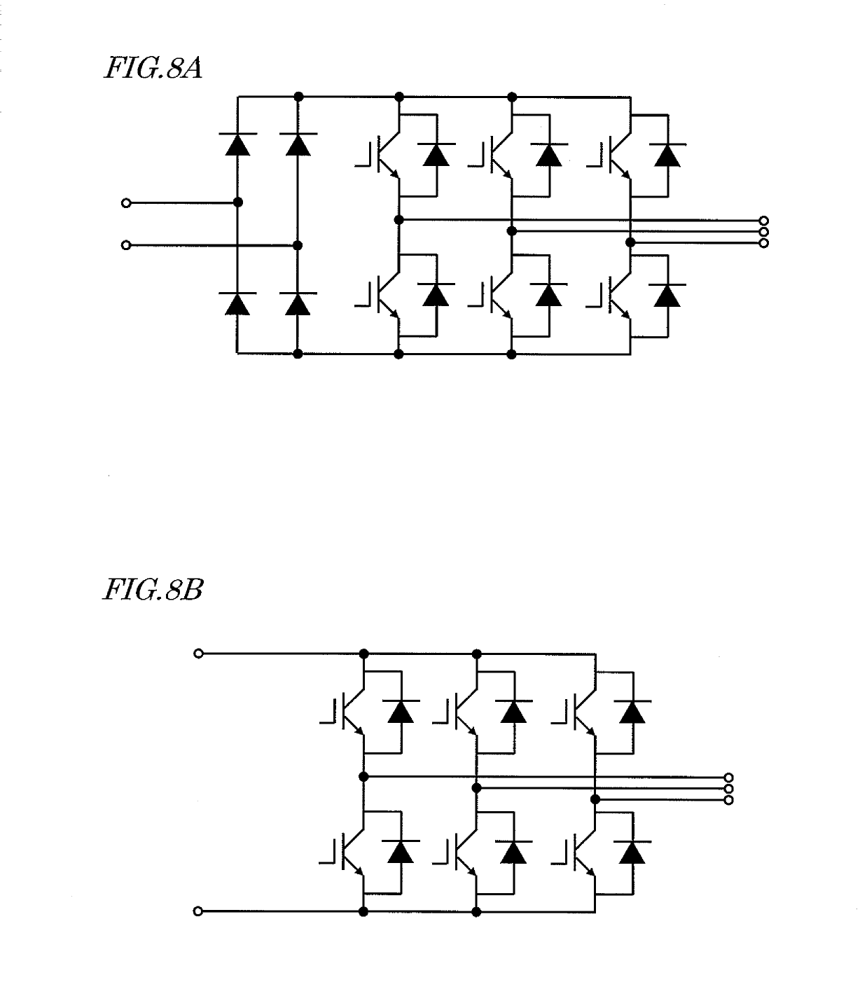

The above-mentioned example of the AC converting and outputting section 111 includes a rectifier circuit for converting AC of the frequency f0 into DC and an inverter for converting DC into AC of a frequency of 50 Hz or 60 Hz. However, the AC converting and outputting section 111 is not limited to this configuration. Even with the use of an indirect matrix converter exemplified in FIG. 8A, the same conversion as described above can be performed.

The AC converting and outputting section 111 may be a circuit that directly converts HF energy of the frequency f0 into AC energy of a frequency of 50 Hz or 60 Hz. With the use of a direct matrix converter exemplified in FIG. 8B, HF energy of the frequency f0 to be transmitted can be directly converted into three-phase AC energy of a system frequency of 50 Hz or 60 Hz, for example. An HF filter may be provided at a preceding stage of the matrix converter to eliminate a harmonic or a noise component undesirable for conversion into an AC frequency fout.

(HF Outputting Section)

The HF outputting section 113 transmits the input HF power to the HF combining section 123 without any conversion. The HF outputting section 113 is a circuit section including an output terminal connected to the HF combining section 123. Note that, the output switching section 109 and the HF combining section 123 may be directly connected to each other without any component therebetween. In this case, a transmission line between the output switching section 109 and the HF combining section 123 corresponds to the HF outputting section 113.

(Generated Energy Detecting Section)

The generated energy detecting section 110 is connected at a subsequent stage of the receiving antenna 108. The generated energy detecting section 110 is, for example, a known wattmeter. The generated energy detecting section 110 measures electrical energy of HF power received by the receiving antenna 108, and transmits the result to the output control section 130.

(DC Combining Section, AC Combining Section, HF Combining Section)

Next, the configurations of the DC combining section 122, the AC combining section 121, and the HF combining section 123 are described.

The DC combining section 122 combines DC voltages input from the power generating units in accordance with a voltage necessary for the DC load R2, and outputs the combined voltage to the DC load R2. The DC combining section 122 has a circuit configuration illustrated in FIG. 9, for example. The DC combining section 122 in this example has a configuration in which a transmission line is connected to the positive output terminals of the power generating units and another transmission line is connected to the negative output terminals thereof. As illustrated in FIG. 9, it is preferred that the DC combining section 122 include a plurality of diodes for preventing back currents between connection points. With this configuration, DC outputs from the plurality of power generating units are combined. Note that, the DC combining section 122 is not limited to the configuration illustrated in FIG. 9, but may have any configuration as long as DC power output from the plurality of power generating units is combined.

The AC combining section 121 combines the voltages and phases of AC power input from the power generating units, and outputs the combined AC power to the AC load R1. The AC combining section 121 may output the AC power also to the commercial power grid (reverse power flow), in addition to outputting the AC power to the AC load R1.

The HF combining section 123 combines the voltages of HF power input from the power generating units in accordance with a voltage necessary for the HF load R3, and outputs the combined voltage to the HF load R3. The HF combining section 123 has the same configuration as the AC combining section 121.

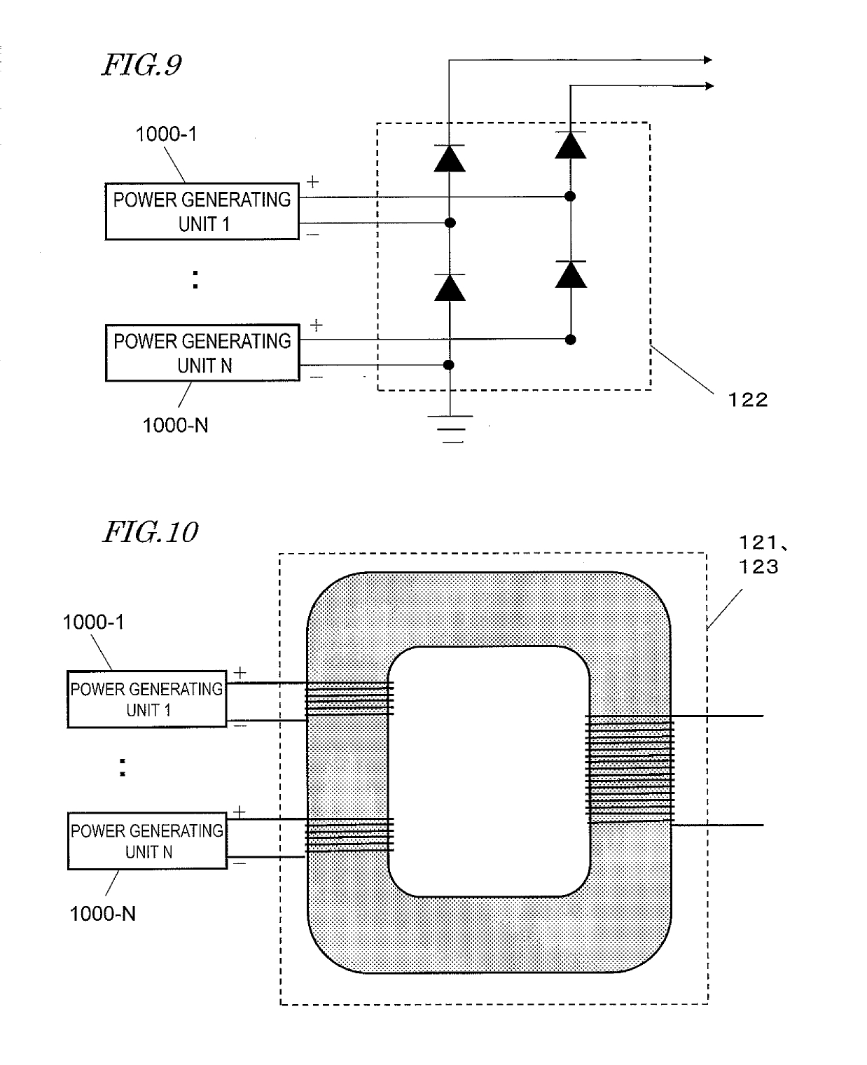

The AC combining section 121 and the HF combining section 123 may have the circuit configuration illustrated in FIG. 9 similarly to the DC combining section 122, or may have another configuration. FIG. 10 is a diagram illustrating another configuration example. In this example, as illustrated in FIG. 10, the AC combining section 121 and the HF combining section 123 have a transformer structure. A conductive line from each of the plurality of power generating units 1000-1 to 1000-N is wound around a conductor such as iron as a primary winding on one side, and an output from a secondary winding on the other side is supplied to the AC load R1 or the HF load R3.

Note that, in order to maximize combining efficiency, it is preferred to match all the voltages of energy output from the power generating units. As an applicable method for matching all the voltages, there is a method of adjusting the voltage step-up ratio by adaptively changing the respective parameters illustrated in FIG. 4. For example, in the case of changing L1 and L2, a plurality of inductors having different turns are prepared and switched as appropriate. In the case of adjusting the coupling coefficient k, the positional relation of the transmitting/receiving antennas (distance or deviation) is changed as appropriate. The output voltage may be adjusted by changing a drive frequency of the oscillator 102 or changing a drive pulse width (duty cycle). In the AC combining section 121 and the HF combining section 123, it is possible to match the phases of all input electric power from the viewpoint of improving combining efficiency.

(AC Power Detecting Section, DC Power Detecting Section, HF Power Detecting Section)

The AC power detecting section 201, the DC power detecting section 202, and the HF power detecting section 203 are, for example, a publicly-known ammeter. The AC power detecting section 201 detects a current flowing from the commercial power grid P into the AC load R1, to thereby detect power consumption (load amount) of the AC load R1. The DC power detecting section 202 detects a current flowing from the commercial power grid P into the DC load R2, to thereby detect power consumption of the DC load R2. The HF power detecting section 203 detects a current flowing from the commercial power grid P into the HF load R3, to thereby detect power consumption of the HF load R3. Specifically, when each load changes, power consumption changes, and hence a current flowing from the commercial power grid P into the corresponding load changes. The voltage applied to the load is constant, and hence, by detecting the current, the power consumption and the load amount can be detected. As described above, the electric power detection as used herein also includes a method of detecting a current to detect electric power indirectly. Note that, instead of detecting the current flowing from the commercial power grid P to each load, the currents flowing from the AC combining section 121, the DC combining section 122, and the HF combining section 123 into the respective loads may be detected. Alternatively, instead of the current detection, power consumption of the load may be directly detected by a wattmeter or the like. Information indicating the power consumption (load amounts) detected by the AC power detecting section 201, the DC power detecting section 202, and the HF power detecting section 203 is transmitted to the output control section 130.

(Output Control Section)

Next, the operation of the output control section 130 is described. The output control section 130 controls the output of each power generating unit by a combination of hardware including a central processing unit (CPU) and a program, for example. The output control section 130 inputs the information indicating the generated energy from the generated energy detecting section 110 of each power generating unit and also the information indicating the power consumption (or the load amounts) of the loads detected by the AC load detecting section 201, the DC load detecting section 202, and the HF load detecting section 203. The output control section 130 determines, for each power generating unit, from which one of the AC converting and outputting section 111, the DC converting and outputting section 112, and the HF combining section 123 electric power is to be output, based on the information of the generated energy of each power generating unit and the power consumption of each load and according to the following rule. Then, the output control section 130 transmits a command (control signal) for instructing an output destination to the output switching section 109 of each power generating unit.

In the initial state, the electric power to each load is supplied from the commercial power grid P, and the output switching section 109 of each power generating unit is set so as to transmit HF power to the AC converting and outputting section 111. From this state, control by the output control section 130 is started at timing of the start of power generation of each power generating unit.

First, the output control section 130 sequentially switches the output destinations of the output switching sections 109 from the AC converting and outputting section 111 to the HF outputting section 113 in order from the first power generating unit 1000-1 until power consumption of the HF load R3 is fulfilled. In this case, the output control section 130 switches the output destinations until the total generated energy of the power generating units whose output destinations have been switched to the HF outputting section 113 reaches a value just before exceeding the power consumption of the HF load R3. When it is determined that the total generated energy will exceed the power consumption of the HF load R3 if the output destination of the next power generating unit is switched, the output control section 130 switches the output destination of the next output switching section 109 to the DC converting and outputting section 112. Then, the output destinations of the remaining power generating units are sequentially switched to the DC converting and outputting section 112 until just before the total generated energy of the power generating units whose output destinations have been switched to the DC converting and outputting section 112 exceeds power consumption of the DC load R2. When the power consumption of the DC load R2 is almost fulfilled, the output switching of the output switching section 109 is finished. The remaining power generating units are controlled to output electric power to the AC combining section 121 via the AC converting and outputting section 111. Through the operation described above, electric power necessary for the HF load R3 and the DC load R2 is supplied from the power generating units whose output destinations have been switched, and electric power necessary for the AC load R3 is supplied from the remaining power generating units.

The operation described above is an example for the case where the generated energy is large enough. In the case where the generated energy is insufficient, insufficient energy is supplied from the commercial power grid P. In the case where the generated energy exceeds power consumption required by all loads, on the other hand, surplus electric power may be subjected to reverse flow to the commercial power grid P (electric power selling).

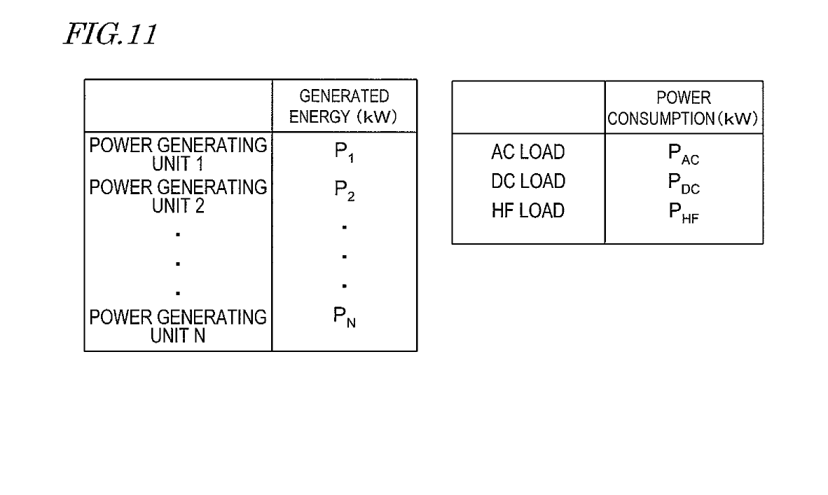

FIG. 11 is a table showing an example of generated energy of each power generating unit and power consumption of each load at certain timing. As a result of measurement, the generated energy of the power generating units 1 to N is P₁ to P_{N}, respectively, and power consumption of the AC load, the DC load, and the HF load is P_{AC}, P_{DC}, and P_{HF}, respectively.

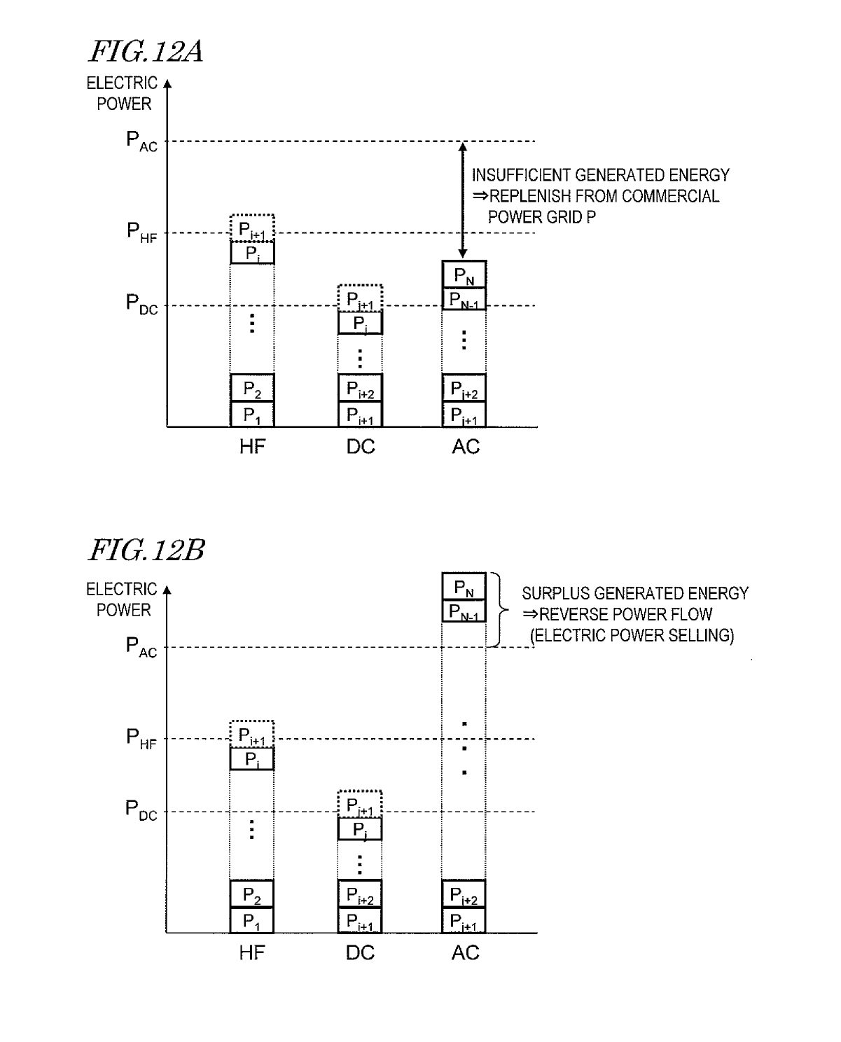

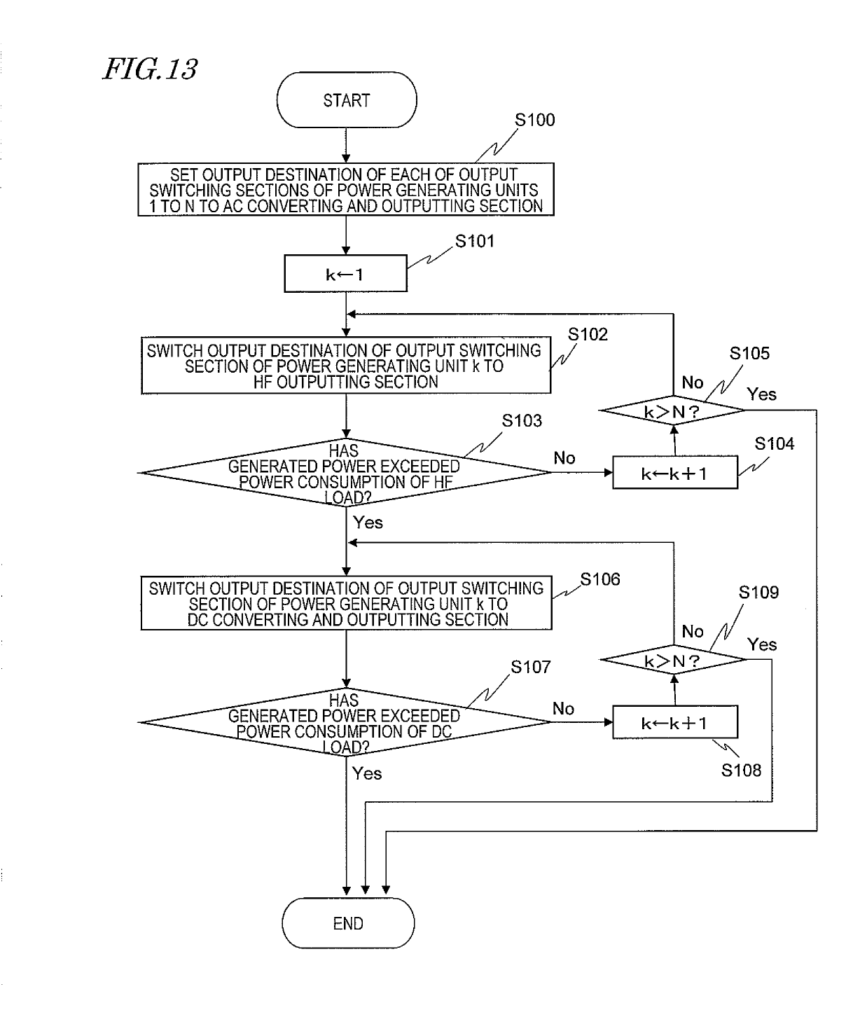

FIG. 12A is a graph showing an example of the result of the above-mentioned control. In this example, the total of P₁ to Pᵢ almost fulfills the power consumption P_{HF} of the HF load R3 and the total of Pᵢ₊₁ to Pⱼ almost fulfills the power consumption P_{DC} of the DC load R2, but the total of Pⱼ₊₁ to P_{N} does not reach the power consumption P_{AC} of the AC load R1. In this case, the shortage of generated energy for the AC load R1 is replenished from the commercial AC power supply P.

FIG. 12B is a graph showing another example of the result of the above-mentioned control. In this example, the total of P₁ to Pᵢ almost fulfills the power consumption P_{HF} of the HF load R3 and the total of Pᵢ₊₁ to Pᵢ almost fulfills the power consumption P_{DC} of the DC load R2, but the total of Pⱼ₊₁ to P_{N} exceeds the power consumption P_{AC} of the AC load R1. In this case, surplus generated energy can be subjected to reverse flow to the commercial AC power supply P (electric power selling).

Note that, in the above-mentioned examples, the generated energy fulfills the power consumption of the DC load R2 and the HF load R3, but may fall short of the power consumption. In this case, insufficient energy is replenished from the commercial AC power supply P. According to the control in this embodiment, the output is switched just before the total of generated energy reaches the power consumption of the DC load R2 and the HF load R3, and hence electric power falls slightly short for the DC load R2 and the HF load R3. Such insufficient energy is replenished from the commercial AC power supply P.

FIG. 13 is a flowchart illustrating an exemplary algorithm for the above-mentioned output control performed by the output control section 130. First, in Step S100, the output control section 130 sets the output destination of each of the output switching sections 109 of the power generating units 1 to N to the AC converting and outputting section 111. Next, in Step S101, 1 is substituted into a variable k. Subsequently, in Step S102, the output destination of the output switching section 109 of the power generating unit k is switched to the HF outputting section 113. In Step S103, it is determined whether or not the total generated energy of the power generating units whose output destinations of the output switching sections 109 have been switched to the HF outputting section 113 exceeds power consumption of the HF load R3. When it is determined that the total generated energy has not exceed the power consumption of the HF load R3, 1 is added to the variable k in Step S104, and the magnitude relation of k and N is determined in Step S105. When it is determined that k is not larger than N, the process returns to Step S102, where the output destination of the output switching section 109 of the next power generating unit is switched to the HF outputting section 113. When it is determined in Step S105 that k is larger than N, the process is finished.

When it is determined in Step S103 that the total generated energy of the power generating units whose output destinations of the output switching sections 109 have been switched to the HF outputting section 113 has exceeded the power consumption of the HF load R3, the process proceeds to Step S106. In Step S106, the output control section 130 switches the output destination of the output switching section 109 of the power generating unit k to the DC converting and outputting section 112. Then, in Step S107, it is determined whether or not the total generated energy of the power generating units whose output destinations of the output switching sections 109 have been switched to the DC converting and outputting section 112 exceeds power consumption of the DC load R2. When it is determined that the total generated energy has exceeded the power consumption of the DC load R2, the process is finished. When it is determined that the total generated energy has not exceeded the power consumption of the DC load R2, the process proceeds to Step S108. In Step S108, 1 is added to the variable k. In Step S109, the magnitude relation of k and N is determined. When it is determined that k is not larger than N, the process returns to Step S106, where the output destination of the output switching section 109 of the next power generating unit is switched to the DC converting and outputting section 112. When it is determined in Step S109 that k is larger than N, the process is finished.

The output control section 130 dynamically executes the above-mentioned control in accordance with the fluctuations in generated energy of each power generating device and/or the fluctuations in power consumption of each load. For example, when the DC load amount is reduced, the output control section 130 instructs the output switching section 109 to switch the output destination of one power generating unit for which the DC converting and outputting section 112 has been specified as the output destination, to the AC converting and outputting section 111. This control may be performed every given time period (for example, several milliseconds).

Whether or not the load amount or power consumption of each load has changed can be determined based on, for example, a value of the current flowing from commercial power grid P to each load. For example, when the load has increased, the current flowing from the commercial power grid P into the load increases. In this case, the outputs of some power generating units are switched so that the current may approach zero.

As described above, the output control section 130 in this embodiment controls, for each power generating unit, the output destination of HF power received by the receiving antenna 108 to switch in the order of the HF outputting section 113, the DC converting and outputting section 112, and the AC converting and outputting section 113. In this way, the generated electric power of each power generating unit can be allocated to the respective loads without any waste. As a result, as compared to the case where HF power of all power generating units is converted at one time into AC power or DC power, the number of power conversions in each power generating unit can be reduced, and hence the conversion efficiency in the overall system can be improved.

In the case of combining the conventional DC power distribution system with a wireless power transmission power generating system, in order to supply electric power to HF loads (for example, non-contact rechargeable electric vehicle and home appliances) in the house, it is necessary to perform conversion from AC power or DC power into HF power, and hence a loss becomes larger. In contrast, the power generating system in this embodiment is capable of supplying HF power transmitted by wireless directly to the HF load without any conversion, and is therefore capable of suppressing the reduction in efficiency caused by power conversion.

Note that, in this embodiment, in regard to the order of output switching of each power generating unit, the switching is performed preferentially in the order of HF output, DC output, and AC output. However, the order may be different. For example, the AC output may have priority over the DC output, or the DC output or the AC output may have priority over the HF output. Note that, when priority is given to the HF output for which power conversion is not performed in the power generating unit, the reduction in efficiency caused by power conversion can be suppressed to the minimum. Which of the DC output and the AC output is to be given priority may be determined based on the conversion efficiency of the DC output and the AC output. For example, priority may be given to one having a higher conversion efficiency.

The control by the output control section 130 is not limited to the above-mentioned example, and may be any type of control as long as the output destination of each power generating unit is determined based on power consumption (including load amount and current) of at least one of the loads. For example, when priority is given to power supply to the AC load R1, control is possibly performed so that electric power is distributed to the AC load R1 based only on power consumption of the AC load R1 while the remaining electric power is all distributed to the HF load R3.

(Boosting Effect by Wireless Power Transmission)

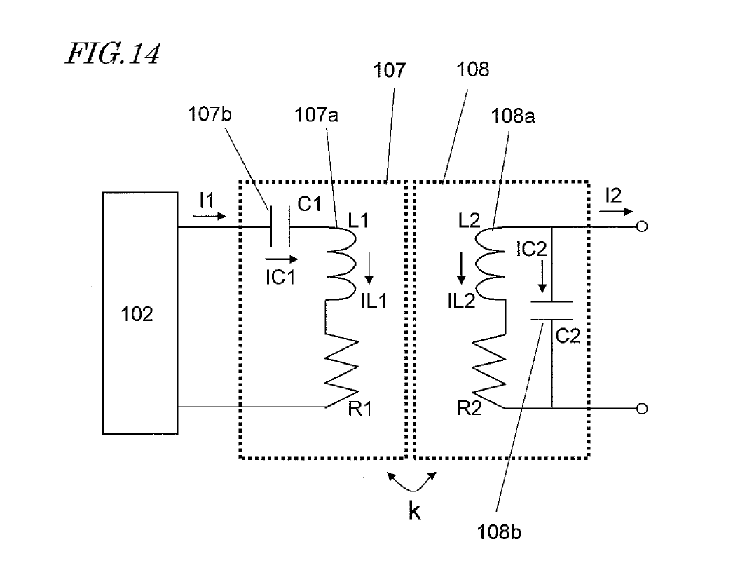

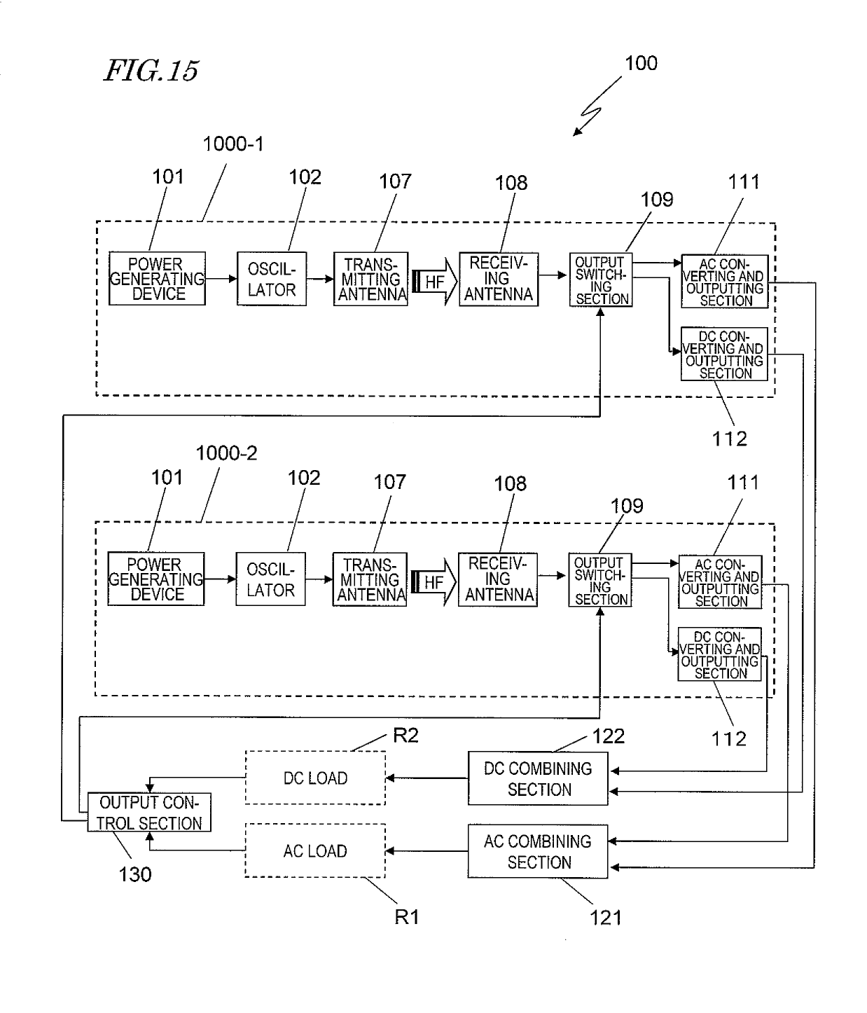

Next, a boosting effect obtained by wireless power transmission in each power generating unit according to this embodiment is described with reference to FIG. 14. First, description is given of a boosting effect in the case where no frequency conversion is performed at the subsequent stage of the receiving antenna 108, that is, the case where electric power is output via the HF outputting section 113.

In general, it is known that, when two resonators having specific resonant frequencies are electromagnetically coupled together, the resonant frequencies change. As in this embodiment, even when the two resonators have the same resonant frequency (frequency: f0), the resonant frequency as the pair of resonators is discretized into two frequencies. Of the two resonant frequencies exhibited by the pair of the coupled resonators, a higher frequency is referred to as even-mode resonant frequency. On the other hand, a lower frequency is referred to as odd-mode resonant frequency. In the following, the even-mode resonant frequency is represented by fL, and the odd-mode resonant frequency is represented by fH.

It is herein supposed that the transmitting antenna 107 and the receiving antenna 108 are coupled together with the coupling coefficient k. The coupling coefficient k is expressed by the following Equation 2 using fL and fH.

k=(fH2−fL2)/(fH2+fL2) (Eq. 2)

As the coupling becomes stronger, the value of k becomes larger, and the discrete amount of the two resonant frequencies increases.

It is possible that the frequency f0 of the oscillator 102 be set to be close to the resonant frequencies fL and fH. More specifically, when the Q factors of the pair of coupled resonators at the resonant frequencies fL and fH are represented by QL and QH, respectively, it is possible to set £0 so as to satisfy the following Equation (3).

fL−fL/QL≦f0≦fH+fH/QH (Eq. 3)

Further, the mutual inductance S produced between the inductor 107a with the inductance L1 and the inductor 108a with the inductance L2 and the coupling coefficient k satisfy the following relationship.

S=k×(L1×L2)^{0.5} (Eq. 4)

In the parallel resonant circuit of the receiving antenna 108, when a high-frequency current flowing through the inductor 108a is represented by IL2 and a high-frequency current flowing through the capacitive element 108b is represented by IC2, the output high-frequency current I2 flowing in the direction illustrated in FIG. 14 is represented by the following Equation.

I2=−IL2−IC2 (Eq. 5)

Further, when a high-frequency current flowing through the inductor 107a of the transmitting antenna 107 is represented by IL1, the following Equation can be derived using the high-frequency current IL2 flowing through the inductor 108a of the receiving antenna 108, the high-frequency current IC2 flowing through the capacitive element 108b, the inductance L2 of the inductor 108a, the parasitic resistance R2 of the inductor 108a, the inductance L1 of the inductor 107a of the transmitting antenna 107 and the capacitance C2 of the capacitive element 108b.

(R2+jωL2)×IL2+jωM×IL1=IC2/(jωC2) (Eq. 6)

where ω=2πf0.

Because the resonance condition is satisfied by the receiving antenna 108, the following Equation 7 is satisfied.

ωL2=1/(ωC2) (Eq. 7)

The following Equation can be derived from Equations 5 to 7.

R2×IL2+jωM×IL1=jωL2×I2 (Eq. 8)

By modifying this Equation 8, the following Equation is obtained.

I2=k×(L1/L2)^{0.5}×IL1−j(R2/ωL2)×IL2 (Eq. 9)

On the other hand, an index Q factor for evaluating the degree of low loss of the resonator of the transmitting antenna 107 is given by the following Equation 10.

Q2=ωL2/R2 (Eq. 10)

In this case, when the Q factor of the resonator is very high, approximation that neglects the second term of the right side of Equation 9 is permitted. Thus, the magnitude of the high-frequency current (output current) I2 produced by the receiving antenna 108 is eventually derived by the following Equation 11.

I2=k×(L1/L2)^{0.5}×IL1 (Eq. 11)

As can be seen from Equation 11, the high-frequency current I2 depends on the high-frequency current I1 input to the transmitting antenna 107 (=high-frequency current IL1 flowing through the inductor 107a), the coupling coefficient k between the resonators (antennas), and the inductances L1 and L2.

As can be seen from Equation 11, the current boost ratio Ir of each power generating unit 100 of this embodiment is represented by the following Equation 12.

Ir=|I2/I1|/Voc=k/Voc×(L1/L2)^{0.5} (Eq. 12)

The current boost ratio of the power generating unit 100 represented by Equation 12 is obtained as the product of the current boost ratio between the transmitting antenna 107 and the receiving antenna 108 and that of the oscillator 103 (which is the inverse number of its voltage step-up ratio Voc).

Further, the voltage step-up ratio Vr and the impedance conversion ratio Zr are given by the following Equations 13 and 14, respectively.

Vr=(Voc/k)×(L2/L1)^{0.5} (Eq. 13)

Zr=(Voc/k)²×(L2/L1) (Eq. 14)

As can be seen from Equation 13, when (L2/L1)>(k/Voc)² is satisfied, the voltage step-up ratio Vr is greater than one. Thus, it can be seen that as the coupling coefficient k falls, the voltage step-up ratio Vr rises. According to the conventional energy transfer method by electromagnetic induction, a decrease in coupling coefficient k leads to a steep decrease in transfer efficiency. According to the resonant magnetic coupling method of this embodiment, however, any decrease in coupling coefficient k never causes such a steep decrease in transfer efficiency. Particularly, when the respective Q factors of the resonators that are used as the transmitting antenna 107 and the receiving antenna 108 are set to be high values, the decrease in transfer efficiency can be minimized with the voltage step-up ratio Vr increased.

To avoid the influence of partial shading on a solar power generation system, a parallel connection of a plurality of solar power generating sections may be adopted rather than a series connection of a large number of solar power generating sections. To make a parallel connection of two solar power generating sections realize the same voltage characteristic as what is normally achieved by a series connection of two solar power generating sections, the output voltages of the respective solar power generating sections need to be doubled.

As can be seen from Equation 12, the voltage step-up ratio Vr becomes equal to two when (L2/L1)=4×(k/Voc)² is satisfied. Because that relation (L2/L1)≧4×(k/Voc)² is satisfied in this embodiment, a voltage step-up ratio Vr of 2 or more can be achieved.

Further, when (L2/L1)≧100×(k/Voc)² is satisfied, a voltage step-up ratio Vr of 10 or more is achieved. When (L2/L1)≧10000×(k/Voc)² is satisfied, a voltage step-up ratio Vr of 100 or more is achieved.

It is easy for the power generating unit and the power generating system of this embodiment to set the k, Voc, L2 and L1 values so as to achieve such a high voltage step-up ratio Vr.

(Boosting Effect Including Outputting Section)

In the outputting section 114 of this embodiment, the ratio of the voltage supplied to the outputting section 114 to the output voltage thereof, that is, the voltage step-up ratio Vtr, varies depending on the conversion method. For example, the input voltage can be doubled when a voltage doubler rectifier circuit is used. With a matrix converter, however, the output voltage can be at most about 0.87 times as high as the input voltage. Further, the voltage step-up ratio Vtr also varies depending on whether or not an AC filter or an HF filter is provided and depending on the operating condition of a boost chopper circuit and the circuit loss thereof. For example, in order to supply a flow of energy to the system, the output voltage Vsys of the outputting section 114 need to fall within the range of V0±Vf (V). Here, a voltage V0 is a system voltage, and Vf is a permissible amount of fluctuation from V0. “V0±Vf” indicates a range from “V0−Vf” to “V0+Vf”.

For example, the energy flow to be supplied to a Japanese power company's utility grid is defined to satisfy V0=202 and Vf=20. When the voltage of the energy provided by the power generating device is represented by Vgen, the voltage step-up ratio Vr (=Vsys/Vgen) and the impedance conversion ratio Zr of the overall power generating unit of this embodiment are rewritten with the voltage step-up ratio Vtr of the outputting section 114 into the following Equations 15 and 16.

Vr=(Voc×Vtr/k)×(L2/L1)^{0.5} (Eq. 15)

Zr=(Voc×Vtr/k)²×(L2/L1) (Eq. 16)

According to this embodiment, when the relation (L2/L1)>(k/(Voc×Vtr))² is satisfied, the voltage step-up ratio can be greater than one as can be seen from Equation 15.

To achieve a voltage step-up ratio Vr of two or more, (L2/L1)≧4×(k/(Voc×Vtr))² needs to be satisfied. When (L2/L1)≧100×(k/(Voc×Vtr))² is satisfied, a voltage step-up ratio Vr of 10 or more is achieved. For example, when Vgen=40 V and Vsys=182 to 222 V (202±20V) are satisfied, then Vr may fall within the range of 4.55 to 5.55. Therefore, L1, L2, k, Voc and Vtr need to be adjusted so as to satisfy:

4.55²×(k/(Voc×Vtr))²≦(L2/L1)≦5.55²×(k/(Voc×Vtr))².

Thus, when the Vgen value is fixed at 40 V, Vsys can fall within the range of 182 V to 222 V even if the voltage step-up ratio varies within the range of 4.55 to 5.55.

### Modified Example

In this embodiment, as illustrated in FIG. 4, in each power generating unit, the transmitting antenna 107 is a series resonance circuit and the receiving antenna 108 is a parallel resonance circuit. The present disclosure, however, is not limited to this combination. For example, the transmitting antenna 107 may be a parallel resonance circuit and the receiving antenna 108 may be a series resonance circuit. Alternatively, both the antennas may be series resonance circuits, or both the antennas may be parallel resonance circuits. Although the boost condition shown in Equation 1 is established in the above embodiment, this condition is not essential in the present disclosure.

The power generating units in this embodiment have the same configuration. However, some power generating units may have different configurations. For example, some power generating units may output electric power not in the three kinds of output forms of AC, DC, and HF but in one or two kinds of the output forms. Further, the frequency f0 of HF energy output from the oscillator 102 is not always required to strictly coincide among all the power generating units.

In this embodiment, the AC converting and outputting section 111 converts the input HF power into AC power of 50 Hz or 60 Hz. Alternatively, however, the AC converting and outputting section 111 may convert the input HF power into AC power of another frequency. The AC converting and outputting section 111 may convert the input HF power into AC power of any frequency lower than the frequency of the HF power.

Further, the HF outputting section 113 and the HF combining section 123 may not be provided. In this case, the output switching section 109 of each power generating unit is configured to transmit HF energy received by the receiving antenna 108 to the AC converting and outputting section 111 or the DC converting and outputting section 112. In the case where no HF load is installed, the HF outputting section 113 and the HF combining section 123 are unnecessary because HF energy is not directly used.

Further, the generated energy detecting section 110 may not be provided. In the case where the generated energy detecting section 110 is not provided, the output control section 130 is configured to switch the output destinations in the order of the power generating units 1 to N, for example. In this case, although the efficiency improvement effect is reduced, there is an advantage that the control of the control section 130 becomes simpler.

Further, in the above-mentioned embodiment, power consumption of the respective loads is detected by the AC power detecting section 201, the DC power detecting section 202, and the HF power detecting section 203, but the present disclosure is not limited thereto. For example, the power consumption may be detected by detecting the current values of the respective loads by the output control section 130 itself. The method of measuring power consumption is optional, as long as the output control section 130 can detect the power consumption of the respective loads.

FIG. 15 is a block diagram illustrating a configuration including two power generating units obtained by excluding, from the power generating system 100 in the above-mentioned embodiment, the HF outputting section 113, the HF combining section 123, the generated energy detecting section 110, the AC power detecting section 201, the DC power detecting section 202, and the HF power detecting section 203. As illustrated in FIG. 15, the power generating system 100 only needs to include at least two power generating units 1000-1 and 1000-2. Further, each power generating unit may not include the HF outputting section 113.

In the power generating system 100 illustrated in FIG. 15, HF energy received by the receiving antenna 108 is transmitted to the AC converting and outputting section 111 or the DC converting and outputting section 112. The output control section 130 controls the output switching section 109 based on power consumption of at least one of the DC load R2 and the AC load R1. This configuration enables efficient power distribution to the AC load R1 and the DC load R2.

Note that, the power generating system 100 in the embodiments described above is not limited to a solar power generating system, but is applicable to other power generating systems such as a fuel cell power generating system. Further, the DC load R2 is not necessarily formed only of electric equipment that operates with DC power, but may include a battery. If such a battery is provided, for example, when electric power is supplied to all loads and the generated electric power is surplus, the surplus electric power can be charged in the battery as well as electric power selling.

In the above embodiments, each power generating unit has a power generating device, but a wireless power transmission system can be built without the power generating device. By combining such a wireless power transmission system and the power generating devices, which have been prepared independently, the power generating system described above may be built.

The power generating system and the power transmission system according to the present disclosure is capable of distributing generated electric power to the respective loads efficiently, and is therefore effective for, for example, a solar power generating system and a fuel cell power generating system.

While the exemplary embodiments of the invention has been described, it will be apparent to those skilled in the art that the disclosed exemplary embodiments may be modified in numerous ways and may assume many embodiments other than those specifically described above. Accordingly, it is intended by the appended claims to cover all modifications of the exemplary embodiments that fall within the true spirit and scope of the invention.

What is claimed is:

1. A power generating system, comprising:
a plurality of power generating units, each of the units including:
a power generating device configured to output DC energy;
an oscillator configured to convert the DC energy output from the power generating device into high-frequency energy and output the converted high-frequency energy;
a transmitting antenna configured to transmit the high-frequency energy output from the oscillator;
a receiving antenna configured to receive at least part of the high-frequency energy transmitted by the transmitting antenna;
an AC converting and outputting section configured to convert the high-frequency energy into AC energy having a relatively low frequency and outputting the converted AC energy;
a DC converting and outputting section configured to convert the high-frequency energy into DC energy and outputting the converted DC energy; and
an output switching section configured to connect a plurality of outputting sections including the AC converting and outputting section and the DC converting and outputting section to the receiving antenna, the output switching section being configured to transmit the high-frequency energy received by the receiving antenna to any one of the plurality of outputting sections based on a control signal;
an AC combining section configured to combine. AC energy output from the AC converting and outputting sections of the plurality of power generating units and supplying the combined AC energy to an AC load;
a DC combining section configured to combine DC energy output from the DC converting and outputting sections of the plurality of power generating units and supplying the combined DC energy to a DC load; and
an output control section configured to control an output of each of the plurality of power generating units by transmitting the control signal to the output switching section of each of the plurality of power generating units based on power consumption of at least one of the AC load and the DC load.

2. The power generating system of claim 1, wherein the output control section generates the control signal based on power consumption of both of the AC load and the DC load.

3. The power generating system of claim 1, further comprising:
an AC power detecting section configured to detect the power consumption of the AC load and notifying the output control section of the detected power consumption; and
a DC power detecting section configured to detect the power consumption of the DC load and notifying the output control section of the detected power consumption.

4. The power generating system of claim 1, wherein:
each of the plurality of power generating units further includes a generated energy detecting section for detecting a magnitude of the high-frequency energy output from the receiving antenna; and
the output control section generates the control signal based on the magnitude of the high-frequency energy detected by the generated energy detecting section.

5. The power generating system of claim 1, wherein:
each of the plurality of power generating units further includes an HF outputting section configured to output the received high-frequency energy without any conversion;
the power generating system further comprises an HF combining section configured to combine the high-frequency energy output from the HF outputting sections of the plurality of power generating units and supplying the combined HF energy to an HF load; and
the output control section controls the output of each of the plurality of power generating units based on power consumption of the HF load.

6. The power generating system of claim 5, wherein the output control section controls the output of each of the plurality of power generating units so that electric power supply to the HF load has priority over electric power supply to the AC load and the DC load.

7. The power generating system of claim 5, wherein each of the plurality of power generating units further includes an HF power detecting section configured to detect the power consumption of the HF load and notifying the output control section of the detected power consumption.

8. The power generating system of claim 5, wherein the output control section controls the output of each of the plurality of power generating units based on the power consumption of each of the AC load, the DC load, and the HF load detected by a current amount flowing through each of the AC load, the DC load, and the HF load.

9. The power generating system of claim 8, wherein the output control section transmits the control signal to the output switching section in each of the plurality of power generating units so that the current amount flowing through the AC load, the DC load, and the HF load approaches 0.

10. The power generating system of claim 1, wherein the AC combining section is connected to a power grid.

11. The power generating system of claim 1, wherein one of the transmitting antenna and the receiving antenna in each of the plurality of power generating units includes a series resonance circuit and the other includes a parallel resonance circuit.

12. The power generating system of claim 11, wherein the following equation is satisfied:
(L2/L1)≧(k/Voc)2,
where Voc represents a voltage step-up ratio of the oscillator, L1 represents an inductance of an inductor included in the transmitting antenna, L2 represents an inductance of an inductor included in the receiving antenna, and k represents a coupling coefficient between the transmitting antenna and the receiving antenna in each of the plurality of power generating units.

13. A power generating system, comprising:
a plurality of power generating units, each of the units including:
a power generating device configured to output DC energy;
an oscillator configured to convert the DC energy output from the power generating device into high-frequency energy and output the converted high-frequency energy;
a transmitting antenna configured to transmit the high-frequency energy output from the oscillator;
a receiving antenna configured to receive at least part of the high-frequency energy transmitted by the transmitting antenna;
an AC converting and outputting section configured to convert the high-frequency energy into AC energy having a relatively low frequency and outputting the converted AC energy;
an HF outputting section configured to output the received high-frequency energy without any conversion; and
an output switching section configured to connect a plurality of outputting sections including the AC converting and outputting section and the HF outputting section to the receiving antenna, the output switching section being configured to transmit the high-frequency energy received by the receiving antenna to any one of the plurality of outputting sections based on a control signal;
an AC combining section configured to combine AC energy output from the AC converting and outputting sections of the plurality of power generating units and supplying the combined AC energy to an AC load;
an HF combining section configured to combine the high-frequency energy output from the HF outputting sections of the plurality of power generating units and supplying the combined high-frequency energy to an HF load; and
an output control section configured to control an output of each of the plurality of power generating units by transmitting the control signal to the output switching section of each of the plurality of power generating units based on power consumption of at least one of the AC load and the HF load.

14. A wireless power transmission system for use in claim 1, comprising:
a plurality of power transmission units, each of the units including:
an oscillator configured to convert DC energy into high-frequency energy and output the converted high-frequency energy;
a transmitting antenna configured to transmit the high-frequency energy output from the oscillator;
a receiving antenna configured to receive at least part of the high-frequency energy transmitted by the transmitting antenna;
an AC converting and outputting section configured to convert the high-frequency energy into AC energy having a relatively low frequency and outputting the converted AC energy;
a DC converting and outputting section configured to convert the high-frequency energy into DC energy and outputting the converted DC energy; and
an output switching section configured to connect a plurality of outputting sections including the AC converting and outputting section and the DC converting and outputting section to the receiving antenna, the output switching section being configured to transmit the high-frequency energy received by the receiving antenna to any one of the plurality of outputting sections based on a control signal;
an AC combining section configured to combine AC energy output from the AC converting and outputting sections of the plurality of power transmission units and supplying the combined AC energy to an AC load;
a DC combining section configured to combine DC energy output from the DC converting and outputting sections of the plurality of power transmission units and supplying the combined DC energy to a DC load; and
an output control section configured to control an output of each of the plurality of power transmission units by transmitting the control signal to the output switching section of each of the plurality of power transmission units based on power consumption of at least one of the AC load and the DC load.

15. A wireless power transmission system, comprising:
a plurality of power transmission units, each of the units including:
an oscillator configured to convert DC energy into high-frequency energy and output the converted high-frequency energy;
a transmitting antenna configured to transmit the high-frequency energy output from the oscillator;
a receiving antenna configured to receive at least part of the high-frequency energy transmitted by the transmitting antenna;
an AC converting and outputting section configured to convert the high-frequency energy into AC energy having a relatively low frequency and outputting the converted AC energy;
an HF outputting section configured to output the received high-frequency energy without any conversion; and
an output switching section configured to connect a plurality of outputting sections including the AC converting and outputting section and the HF outputting section to the receiving antenna, the output switching section being configured to transmit the high-frequency energy received by the receiving antenna to any one of the plurality of outputting sections based on a control signal;
an AC combining section configured to combine AC energy output from the AC converting and outputting sections of the plurality of power transmission units and supplying the combined AC energy to an AC load;
an HF combining section configured to combine the high-frequency energy output from the HF outputting sections of the plurality of power transmission units and supplying the combined high-frequency energy to an HF load; and
an output control section configured to control an output of each of the plurality of power transmission units by transmitting the control signal to the output switching section of each of the plurality of power transmission units based on power consumption of at least one of the AC load and the HF load.
